(19) United States
(12) Patent Application Publication
(10) Pub. No.: US 2010/0247876 A1
(43) Pub. Date: Sep. 30, 2010

(54) PRINTING INK COMPOSITION FOR LAMINATE

(75) Inventors: Toshio OMINO, Tokyo (JP); Masumi Takano, Tokyo (JP); Tetsuya Sai, Tokyo (JP); Yuichi Sato, Tokyo (JP); Atsushi Katsuya, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyo Ink Mfg. Co., Ltd., Chuo-ku (JP)

(21) Appl. No.: 12/729,445

(22) Filed: Mar. 23, 2010

(30) Foreign Application Priority Data
Mar. 25, 2009 (JP) 2009-073013
Sep. 30, 2009 (JP) 2009-228683

(51) Int. Cl. B32B 3/10; C09D 175/08

(52) U.S. Cl. 428/201; 428/195.1; 524/41

(57) ABSTRACT

There is provided an ink composition containing a colorant, a solvent, and a binder composed of 80 to 98% by weight of a polyurethane resin, 0.5 to 5% by weight of a cellulose acetate alkylate resin and 1.0 to 15% by weight of a polyvinyl butyral resin, based on the solids content, in which composition the polyurethane resin is obtained by reacting a reaction product between (A) a polyether diol compound having a Mn of 1,000 to 5,000, or a mixture of the compound and a polyester diol having a Mn of 1,000 to 5,000, and (B) a diisocyanate compound, with (C) a hydroxyldialkylamine having a molecular weight of 50 to 300 and having one hydroxyl group in a molecule, and further reacting the product with (D) a chain extending agent; and a molar ratio of the OH group of the component (C) to the NCO group of the component (B) is 0.05 to 0.35.

### FIELD OF THE INVENTION

The present invention relates to a printing ink composition for laminate which is alcohol-soluble and is capable of forming a printed layer on a laminate film by flexographic printing. More particularly, the present invention relates to a printing ink composition for laminate which has excellent a printability to plastic films, and can be suitably used as a printing ink even for the applications of laminate films where boiling resistance and retort resistance are required.

### DESCRIPTION OF THE RELATED ART

In the field of packaging of food products, confectionery, miscellaneous daily goods, pet food or industrial products, packaging materials making use of various plastic films are widely used due to their functions such as design, economical efficiency, protectability of content, transportability and the like. Furthermore, many of the packaging materials are subjected to gravure printing or flexographic printing so as to impart design and message for the purpose of appealing to consumers.

As a representative constitution of printing process that is applicable to the packaging materials, there is known a surface printing process which provides printed layers on the surface of a packaging material, or a back printing process which carries out laminate processing of a film by further applying an adhesive or an anchoring agent to the printed layer if necessary.

In the back printing process, a printed layer is formed on a film base material, and subsequently laminate processing, such as dry laminate processing that makes use of an adhesive or extrusion laminate processing that makes use of an anchor-coating agent, is generally carried out. During the laminate process, various films of polyesters, nylons, aluminum foil and the like, which are excellent in mechanical strength or airtightness, are selected. These films are frequently intended for heat sealing, and are therefore laminated with films such as polyethylene film and polypropylene film. Upon considering the use as a packaging material, it is desirable for a laminate film to have excellent heat seal processability and laminate strength. Furthermore, if the content to be packaged is a ready-to-cook type of food product, the laminate film is required to have processing adaptability for boiling, retort applications and the like.

To address such demands, development of a printing ink is in progress, which has excellent adhesiveness to various films, and is capable of coping with the processing adaptability for boiling, retort applications and the like, without incorporating an isocyanate compound to the printing ink. In addition, this investigation is being conducted in connection with the printing ink described above, with regard to reducing the number of processes concomitant to the incorporation of a curing agent or the loss of the curing agent in ink exchange by preparing the printing ink of a single-component system without incorporating the curing agent such as isocyanate compounds.

Japanese Patent Application Laid-Open (JP-A) No. 2004-175867 proposes a polyurethane resin for flexographic ink, which has hydroxyl groups and is alcohol-soluble, which is obtainable by using a hydroxyl group-containing aliphatic diamine as an alcohol-soluble resin for flexographic ink.

WO 2005/005507 proposes a mixture of a particular urethane resin and a nitrocellulose resin as a printing ink for shrink sleeve labels. WO 2002/38643 proposes a printing ink composition formed from a particular urethane resin, nitrocellulose and a butyral resin, as an ink for laminate.

### SUMMARY OF THE INVENTION

However, when the content to be packaged is a highly transitional material such as spice or an aromatic material, or when a content of heavy weight is to be packaged for business purposes, the print that is applied to the laminate film needs to have chemical resistance or sufficient physical strength secured by the ink film. Accordingly, even if the printing ink for laminate is of a single-component system, in practice, the printing ink is used in a form mixed with an isocyanate compound. Therefore, in the field of printing ink for laminate, an ink composition which has excellent adhesiveness to various films and has processing adaptability for boiling, retort applications and the like, even though being a formulation of the single-component system, is desired. Also, for example, in order to make the ink composition applicable to the applications of packaging special contents such as aromatic substances or spices, an ink composition which undergoes less change in viscosity after an isocyanate-based curing agent is incorporated, has satisfactory storage stability, and is reusable, is desired.

Furthermore, an ink composition which is alcohol-soluble and is capable of efficiently carrying out flexographic printing or gravure printing, which allows high speed printing, is desired. Particularly, in the case of applying flexographic printing to form a printed layer, it is desired that the ink composition has an excellent stringiness, and thereby the ink composition is accompanied by less or no stringing. When the stringiness of the ink composition is poor, after the ink composition has been transferred from a printing plate to a base material such as a film, the remaining ink causes generation of a filamentous dried matter at the edge portions of the printing plate, and there occurs a tendency that the printing effect is deteriorated and it becomes difficult to conduct continuous printing.

Therefore, the present invention was made under the foregoing circumstances, and it is an object of the present invention to provide a printing ink composition for laminate that has excellent adhesiveness to various films, has processing adaptability for boiling, retort applications and the like, and is excellent in the storage stability of the ink even after an isocyanate-based curing agent is incorporated. It is another object of the present invention to provide a printing ink composition for laminate that is alcohol-soluble, has an excellent stringiness, and is suitable for the use in flexographic printing or gravure printing, which allows high speed printing.

The inventors of the present invention devotedly made a thorough investigation on ink components in order to solve the problems mentioned above, and as a result, they found that a printing ink composition excellent in various properties that are desired in the printing technique for laminate films can be provided by using three kinds of particular resins such as a polyurethane resin, a cellulose acetate alkylate resin and a polyvinyl butyral resin in combination as a binder. Thus, they completed the present invention. Generally, in the case of using a printing ink using a urethane resin in the applications of laminate film, it is important to have the adhesiveness to films and the anti-blocking property highly well-balanced, from the viewpoint of the practical performance. According to the present invention, an ink composition having an excellent anti-blocking property in addition to the various desired properties, can be provided by using a particular urethane resin as a binder. That is, the present invention relates to the items described below.

According to a first aspect of the present invention, there is provided a printing ink composition for laminate intended for forming a printed layer on a film base material that is to be lamination processed. The printing ink composition for laminate according to the present invention includes a colorant, a solvent, and a binder composed of 80 to 98% by weight of a polyurethane resin, 0.5 to 5% by weight of a cellulose acetate alkylate resin and 1.0 to 15% by weight of a polyvinyl butyral resin, based on the total weight of a solids content, wherein the polyurethane resin is a polyurethane resin obtainable by reacting a reaction product obtained by a reaction between a component (A) and a component (B) as indicated below, with a component (C) to produce an isocyanate group-containing prepolymer, and further reacting the prepolymer with a component (D), and a molar ratio of the hydroxyl group in the component (C) to the isocyanate group in the component (B) is within a range from 0.05 to 0.35:

(A) a polyether diol compound having a number average molecular weight of 1,000 to 5,000, or a mixture of the polyether diol compound and a polyester diol compound having a number average molecular weight of 1,000 to 5,000;

(B) a diisocyanate compound;

(C) a hydroxyldialkylamine compound having a molecular weight of 50 to 300 and having one hydroxyl group in a molecule; and

(D) a chain extending agent.

Here, in regard to the printing ink composition for laminate, the cellulose acetate alkylate resin is preferably a cellulose acetate propionate resin. The hydroxyldialkylamine compound is preferably at least one of diethylaminoethanol and dimethylaminoethanol. The polyether diol compound is preferably polytetramethylene glycol.

In regard to the printing ink composition for laminate, a weight ratio of the polyether diol compound to the polyester diol compound is preferably within a range from 100/0 to 20/80.

Furthermore, in regard to the printing ink composition for laminate, the amine value of the polyurethane resin is preferably within a range from 0.5 to 10.

According to a second aspect of the present invention, there is provided a flexographic printed matter which is obtainable by forming a printed layer on a film base material according to a flexographic printing technique, using the printing ink composition for laminate.

According to a third aspect of the present invention, there is provided a laminate film which is obtainable by laminating a plastic film on the printed layer of the flexographic printed matter.

According to a fourth aspect of the present invention, there is provided a packaging material for food products, which includes the laminate film.

The present patent application relates to subject matters that are also encompassed by Japanese Patent Application No. 2009-73013 filed on Mar. 25, 2009, and Japanese Patent Application No. 2009-228683 filed on Sep. 30, 2009, both by the present applicant, the disclosures of which are incorporated herein as a part of the present specification by reference.

According to the present invention, an ink composition can be provided, which has excellent adhesiveness to various films and an excellent anti-blocking property and has excellent processing adaptability for boiling, retort applications and the like, and which is suitable as an ink for forming a printed layer in a laminate film. The ink composition according to the present invention has satisfactory solubility in alcohol-based solvents and also has an excellent threading property, and therefore, the ink composition is applicable to flexographic printing which makes use of a resin plate, as well as to gravure printing. The ink composition according to the present invention is such that the increase in the ink viscosity is smaller and the storage viscosity is stabilized, even after an isocyanate-based curing agent is added to the ink composition as a curing agent used for preparing two-component system.

### BRIEF DESCRIPTION OF THE DRAWING

FIG. 1 is a schematic cross-sectional view showing the laminate film according to an embodiment of the present invention.

### DETAILED DESCRIPTION OF THE PREFERRED EMBODIMENTS

Hereinafter, the present invention will be described in detail.

### (Printing Ink Composition)

The printing ink composition for laminate according to the present invention contains a colorant, a solvent and a binder composed of three particular resin components. The details of the various components used for the preparation of the ink composition according to the present invention are as follows.

### (Binder Component)

The binder used in the present invention is composed of (i) 80 to 98% by weight of a polyurethane resin, (ii) 0.5 to 5% by weight of a cellulose acetate alkylate resin, and (iii) 1.0 to 15% by weight of a polyvinyl butyral resin, based on the total weight of the solids content.

### (i) Urethane Resin

The polyurethane resin is a polyurethane resin obtainable by reacting a product obtained by a reaction between a component (A) and a component (B) as indicated below, with a component (C) to produce an isocyanate group-containing prepolymer, and further reacting the prepolymer with a component (D), in which resin a molar ratio of the hydroxyl group in the component (C) to the isocyanate group in the component (B) is within a range from 0.05 to 0.35:

(A) a polyether diol compound having a number average molecular weight of 1,000 to 5,000, or a mixture of the polyether diol compound and a polyester diol compound having a number average molecular weight of 1,000 to 5,000;

(B) a diisocyanate compound;

(C) a hydroxyldialkylamine compound having a molecular weight of 50 to 300 and having one hydroxyl group in a molecule; and

(D) a chain extending agent.

In the present invention, when the proportion of the particular urethane resin mentioned above in the binder is adjusted to 80% or greater based on the total weight of the solid components, the boiling resistance and retort resistance of the printed surface and the adhesiveness to a polyester film tend to be enhanced. On the other hand, when the proportion is adjusted to 98% or smaller, the anti-blocking property of the printed surface tends to be enhanced.

As a general method for producing a polyurethane resin, there is known a two-step method consisting of a first process for preparing a first isocyanate group-containing prepolymer by reacting a polyol component and an isocyanate component in excess of the isocyanate component, and a second process for further reacting the first prepolymer with a chain extending agent, and with a reaction terminating agent if necessary. On the contrary to this, the present invention is characterized in that, as explained above, a second isocyanate group-containing prepolymer through a process of further reacting the first isocyanate group-containing prepolymer with a hydroxyldialkylamine compound having a molecular weight of 50 to 300 and having one hydroxyl group in a molecule, prior to the second process of performing the chain extension reaction of the prepolymer. According to the present invention, an ink composition excellent in printability such as fluidity, adhesiveness and anti-blocking property can be provided by using, as a main component of the binder, a particular urethane resin that is obtainable by reacting such a second prepolymer with a chain extending agent and with a reaction terminating agent if necessary.

Although it is not intended to be bound by the theory, the second prepolymer is brought to a state in which a portion of the isocyanate groups are capped by the reaction with the component (C), and therefore, the reaction site at the time of the chain extension reaction is restricted. Furthermore, hydroxyl groups are introduced into the second polymer by the reaction with the component (C). Accordingly, it is speculated that in the present invention, a urethane resin which is suitable as a binder component may be obtained by going through a particular reaction process of using the component (C) prior to the chain extension reaction, and by using a specific amount of the component (C) at the time of the reaction process.

In the present invention, a urethane resin which is obtainable using the component (C) in an amount such that a molar ratio of the mole number (M1) of the hydroxyl group in the component (C) to the mole number (M2) of the isocyanate group in the component (B), that is, M1/M2, is within a range from 0.05 to 0.35. When the amount of use of the component (C) is set to adjust the ratio M1/M2 to 0.05 or greater, the compatibility between the urethane resin and other binder components tends to be enhanced. Also, a decrease in the viscosity stability upon incorporating a curing agent (hardener) into the ink composition can be suppressed. On the other hand, when the amount of use of the component (C) is set to adjust the ratio M1/M2 to 0.35 or less, the boiling property of a laminate packaging material which has on the inner side a surface printed with the ink composition, and the anti-blocking property tend to be enhanced. Hereinafter, the components (A) to (D) used for the preparation of the polyurethane resin will be explained.

Component (A): Polyether diol compound having a number average molecular weight of 1,000 to 5,000, or mixture of the polyether diol compound and a polyester diol compound having a number average molecular weight of 1,000 to 5,000.

Specific examples of the polyether diol compound that can be used in the present invention include polyoxytetramethylene glycol, polyethylene glycol and polypropylene glycol. Copolymerized polyether diols of these glycols may also be used. An example thereof may be a compound derived from ethylene glycol and propylene glycol. According to the present invention, among the polyether diol compounds previously mentioned as examples, polyoxytetramethylene glycol is preferred from the viewpoints of adhesiveness and processing adaptability for boiling and retort applications. The number average molecular weight (Mn) of the polyether diol compound used in the present invention is within a range from 1,000 to 5,000, and more preferably within a range from 2,000 to 5,000.

The polyether diol may be used as a mixture with a polyester diol that will be described later. The mixing ratio of the polyether diol to the polyester diol is within a range from 100/0 to 20/80 based on the total weights of the components. The mixing ratio is more preferably within a range from 100/0 to 50/50. When the mixing ratio of the polyester diol is adjusted to 80% or less, the solubility of the obtainable polyurethane resin in an alcohol solvent becomes satisfactory, and the fluidity or gloss of the printing ink tends to be enhanced.

Specific examples of the polyester diol include polyester diols obtainable by a condensation reaction between a dicarboxylic acid and diol. Examples of the dicarboxylic acid include aliphatic dicarboxylic acids such as adipic acid, sebacic acid, succinic acid, glutaric acid, maleic acid and fumaric acid, or anhydrides thereof; and aromatic carboxylic acids such as phthalic acid, isophthalic acid and terephthalic acid, or anhydrides thereof. Examples of the diol include ethylene glycol, propylene glycol, 1,2-butylene glycol, 1,3-butylene glycol, 1,4-butanediol, 2,3-butylene glycol, isobutylene glycol, neopentyl glycol, 2-methyl-2-propyl-1,3-propanediol, 1,5-pentanediol, 1,6-hexanediol, 2-methyl-2,4-pentanediol, 3-methyl-1,5-pentanediol, 2,2,4-trimethyl-1,3-pentanediol, 2-ethyl-1,3-hexanediol, 2,5-methyl-2,5-hexanediol, 1,4-cyclohexanedimethanol, 1,4-butynediol, 1,4-butenediol, 2,5-dimethyl-3-hexyne-2,5-diol; and diols having a carboxyl group, such as dimethylolpropionic acid, dimethylolbutanoic acid, dimethylolbutanoic acid, dimethylolpentanoic acid, dimethylolbutyric acid and dimethylolvaleric acid. Furthermore, a polyester diol having a number average molecular weight of 1,000 or more can also be obtained by reacting a lactone compound such as s-caprolactone or β-methyl-δ-valerolactone with a diol compound such as a diol monomer, a polyester polyol or a polyether, under a temperature condition of 150 to 250° C. The number average molecular weight (Mn) of the polyester diol compound used in the present invention is within a range from 1,000 to 5,000, and more preferably within a range from 2,000 to 5,000.

Component (B): Diisocyanate Compound

Various types of known diisocyanates, including aromatic, aliphatic and alicyclic diisocyanates, may be used as the diisocyanate compound in the present invention. Examples thereof include 1,5-naphthylene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, isopropylene diisocyanate, methylene diisocyanate, 2,2,4-trimethylhexamethylene diisocyanate, 2,4,4-trimethylhexamethylene diisocyanate, cyclohexane-1,4-diisocyanate, xylene diisocyanate, isophorone diisocyanate, lysine diisocyanate, dicyclohexylmethane-4,4′-diisocyanate, 1,3-bis(isocyanatomethyl)cyclohexane, methylcyclohexane diisocyanate, and tetramethylxylene diisocyanate. In addition to those, a dimer diisocyanate obtained as a result of substituting the carboxyl group of a dimer acid with an isocyanate group, may also be used. According to the present invention, it is preferable to use isophorone diisocyanate from the viewpoints of solubility and flexibility.

Component (C): Hydroxyldialkylamine Compound Having a Molecular Weight of 50 to 300 and Having One Hydroxyl Group in a Molecule

The hydroxyldialkylamine compound used in the present invention may be, for example, dimethylaminomethanol, dimethylaminoethanol, dimethylaminopropanol, dimethylaminobutanol, diethylaminomethanol, diethylaminoethanol, diethylaminopropanol, diethylaminobutanol, dipropylaminomethanol, dipropylaminoethanol, dipropylaminopropanol, dipropylaminobutanol, dibutylaminoethanol, dibutylaminopropanol, dibutylaminobutanol, 1-(2-hydroxymethyl)pyrrolidine, 1-(2-hydroxyethyl)pyrrolidine, 1-methyl-2-piperidinemethanol, or 2-hydroxyethylmorpholine. In the present invention, the compounds previously exemplified as the hydroxyldialkylamine compound may be used singly, or may be used in combination of two or more kinds.

Component (D): Chain Extending Agent

The chain extending agent used in the present invention may be a compound having two or more of a functional group that is capable of reacting with an isocyanate group in a molecule, which is well known in the related art. For example, a diamine compound such as ethylenediamine, propylenediamine, hexamethylenediamine, triethylenetetramine, diethylenetriamine, isophoronediamine or dicyclohexylmethane-4,4′-diamine can be used. Furthermore, a diamine compound having a hydroxyl group, such as aminoethylethanolamine may also be used.

In addition to those, a dimer diamine obtained as a result of substituting the carboxyl group of a dimer acid with an amino group, and the like may also be used.

Preparation of Urethane Resin:

The urethane resin that is used in the present invention is obtained using the previously described components (A) to (D), by sequentially carrying out a process of producing a product by a reaction between the component (A) and the component (B), a process of subsequently reacting the obtained product with the component (C) to produce an isocyanate group-containing prepolymer, and a process of subjecting the prepolymer to a chain extension reaction using the chain extending agent of the component (D). Specific synthesis methods for the respectively processes can be carried out by applying well-known techniques. However, in order to produce a polyurethane resin that can manifest the desired characteristics, the amount of use of the component (C) needs to be adjusted such that a molar ratio of the hydroxyl group in the hydroxyldialkylamine compound to the isocyanate group in the component (B) is within a range from 0.05 to 0.35.

According to an embodiment of the present invention, the preparation of the isocyanate group-containing prepolymer can be carried out in the following manner. (1) Firstly, a polyol compound of the component (A) is reacted with an organic diisocyanate compound of the component (B) under a temperature condition within a range from 60 to 120° C. to obtain a product having a predetermined isocyanate content (NCO %). Here, the NCO % can be measured according to a method based on JIS-K1556.

(2) Subsequently, a hydroxyldialkylamine compound of the component (C), which has a molecular weight of 50 to 300 and has one hydroxyl group in a molecule, is added into the flask to react with the product obtained above, and the reaction is continued until a polyurethane prepolymer having a predetermined isocyanate content is obtained.

In the present invention, solvents and catalysts may also be used if necessary, when a series of reactions for producing the urethane resin are carried out. The catalysts used in the present invention may be well-known compounds that are conventionally used in the urethanization of polyurethane resins. Specific examples include stannous octanoate, dibutyltin acetate, and tetrabutoxytitanate. The solvents used at the time of preparation of the urethane resin in the present invention may be known organic solvents that are conventionally used as solvents for printing ink. For example, in the inks for flexographic printing, alcohol-based solvents such as methanol, ethanol, propyl alcohol and butanol; ester-based solvents such as ethyl acetate, propyl acetate and butyl acetate; and polyhydric alcohol derivatives such as ethylene glycol monomethyl ether and ethylene glycol monoethyl ether, which are obtained by etherifying the hydroxyl groups of ethylene glycol and propylene glycol, respectively, are used as diluting solvents, in view of the durability of the resin plate used upon printing. Concerning ethanol, synthetic ethanol and fermented ethanol, which is known as so-called bio-ethanol, can all be used. According to an embodiment of the present invention, it is preferable to use such a solvent at the time of preparation of the urethane resin from the viewpoint of carrying out the reaction uniformly.

According to an embodiment of the present invention, the chain extension reaction can be carried out by adding dropwise the previously prepared polyurethane prepolymer to a mixture containing a chain extending agent such as a diamine compound that is used as the component (D), a solvent and if necessary, a reaction terminating agent, under a temperature condition within a range from 30 to 120° C. A desired polyurethane resin may be obtained by continuing the chain extension reaction until the remaining isocyanate groups all disappear. The previously mentioned solvents may be similarly used during the chain extension reaction. Furthermore, as the reaction terminating agent, a dialkylamine such as dimethylamine, diethylamine or dibutylamine can be used. When the reaction terminating agent is used in addition to the chain extending agent, regulation of the molecular weight is made possible, and the terminal chemical structure of the obtainable urethane resin can be controlled.

Since the polyurethane resin used in the present invention is a resin prepared through a series processes as described above, the molecular weight and the functional valency of the amine group or the like can be easily regulated, as compared with those polyurethane resins obtained by a common two-step method. The weight average molecular weight (Mw) of the polyurethane resin of the present invention is, although not intended to be particularly limited, within a range from 30,000 to 80,000, and more preferably within a range from 40,000 to 70,000. The amine value of the polyurethane resin used in the present invention is within a range from 0.5 to 10, and more preferably within a range from 3 to 8. When the amine value of the polyurethane resin is 0.5 or greater, the adhesiveness to, for example, a corona-treated OPP film can be easily enhanced. On the other hand, when the amine value is 10 or less, retort resistance can be easily enhanced. Here, the term “amine value” as used herein is a value obtained according to a well-known titration method making use of a hydrochloric acid solution.

The printing ink composition according to the present invention includes, as the binder components, (ii) a cellulose acetate alkylate resin and (iii) a polyvinyl butyral resin that will be described later, in addition to the (i) polyurethane resin discussed above.

(ii) Cellulose Acetate Alkylate Resin:

The mixing amount of the (ii) cellulose acetate alkylate resin is adjusted to 0.5 to 5% by weight based on the total weight of the solids content of the binder. When the mixing amount of the component (ii) is set at 0.5% by weight or more, the anti-blocking property of the resulting printing ink composition can be easily enhanced. On the other hand, when the mixing amount of the component (ii) is set at 5% by weight or less, the storage stability and adhesiveness of the printing ink composition can be easily enhanced. In view of enhancing the anti-blocking property of the printing ink composition, many compounds corresponding to the component (ii) are effective. However, upon considering the compatibility with the polyurethane resin used as the component (i), it is preferable to use at least one of cellulose acetate propionate (CAP) and cellulose acetate butyrate (CAB) as the component (ii), and it is more preferable to use cellulose acetate propionate (CAP).

The cellulose acetate propionate and cellulose acetate butyrate used in the binder of the present invention are obtained by a reaction between cellulose and organic acids or acid anhydrides. More specifically, cellulose is mixed with an organic acid or an acid anhydride and a catalyst, and the mixture is allowed to react until a triester is formed. After cellulose has been completely acylated, hydrolysis is carried out until a desired level of hydroxyl groups is reached.

Cellulose acetate propionate is obtained by triesterifying cellulose with acetic acid and propionic acid, and then hydrolyzing the product. In general, resins having a degree of acetylation of 0.6 to 2.5% by weight and a degree of propionation of 42 to 46% by weight, and having a hydroxyl group content of 1.8 to 5%, are commercially available. According to an embodiment of the present invention, it is preferable to use a cellulose acetate propionate resin having a propionyl group content of 40 to 50% by weight (median value 45%), an acetyl group content of 0.5 to 3% by weight (median value 2.5%) and a hydroxyl group content of 2 to 6% by weight (median value 2.5%), and having a viscosity of 0.05 to 0.2 Pas (ASTM Method D1343).

Cellulose acetate butyrate is obtained by triesterifying cellulose with acetic acid and butyric acid, and then hydrolyzing the product. In general, resins having a degree of acetylation of 2 to 30% by weight and a degree of butyrylation of 17 to 53% by weight, and having a hydroxyl group content of 1 to 5%, are commercially available. Nitrocellulose is obtained by esterifying a part or most of the hydroxyl groups of cellulose with acetic acid. There are available nitrocellulose resins having a wide range of degrees of polymerization, and in general, products having an average degree of polymerization of 35 to 480 are commercially available.

(iii) Polyvinyl Butyral Resin:

The mixing amount of the (iii) polyvinyl butyral resin is adjusted to 1.0 to 15% by weight based on the total weight of the solids content of the binder. When the mixing amount of the component (iii) is set at 1.0% by weight or more, the anti-blocking property of the resulting printing ink or the adhesiveness to polyester films can be easily enhanced. On the other hand, when the mixing amount of the component (iii) is set at 15.0% by weight or less, the storage stability of the printing ink composition can be easily enhanced.

The anti-blocking property enhancing effect of the component (iii) is moderate, but the compatibility of the component with other resin components used as the binder is satisfactory. Therefore, various polyvinyl butyral resins can be used as the component (iii) in the present invention. For example, in the present invention, a polyvinyl butyral resin that is obtained by reacting polyvinyl alcohol with butyraldehyde or formaldehyde, and subsequently acetalizing the product, can be used. Although it is not intended to be particularly limited, upon considering the use as a printing ink composition for laminate films, the polyvinyl butyral resin used in the present invention has an acetyl group content of 3% by mole or less, a degree of butyralization within a range from 60 to 80, and a hydroxyl group content of about 36%, and has a number average molecular weight within a range from 10,000 to 50,000, and preferably within a range from about 10,000 to 20,000.

The ink composition according to the present invention contains a colorant and a solvent as essential components, in addition to the foregoing binder. The colorant and solvent will be explained below.

### (Colorant)

According to the present invention, known organic pigments, inorganic pigments, and pigments called extender pigments, which are conventionally used in the technical field of printing ink or paint, can be used as the colorant.

Specific examples of the pigment that can be used in the present invention include Pigment Yellow 1, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 180, Pigment Yellow 188, Pigment Orange 5, Pigment Orange 13, Pigment Orange 16, Pigment Orange 34, Pigment Red 2, Pigment Red 9, Pigment Red 38, Pigment Red 41, Pigment Red 42, Pigment Red 112, Pigment Red 170, Pigment Red 146, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 23, Pigment Black 7, Pigment White 6, and carbon black.

Examples of the extender pigment include carbonic acid salts such as calcium carbonate and magnesium carbonate; sulfuric acid salts such as sedimentary barium sulfate; and silicic acid salts such as silica, talc and mica, and these can be used singly or in combination of two or more kinds. Fillers that are well known in the related art can also be added in order to enhance the anti-blocking property of the ink composition and the laminate strength, and for this purpose, the extender pigments mentioned above may also be used.

The color of the ink composition of the present invention is not particularly limited, and can be adjusted in accordance with the type of the colorant used. According to an embodiment of the present invention, the standard process colors are five colors of yellow, magenta, cyan, black and white, while the extra-gamut process colors are three colors of red (orange), grass (green) and violet. In addition, transparent yellow, fuscia, vermillion, brown, gold, silver, pearl and a nearly transparent medium for color density adjustment (including extender pigments if necessary), and the like are provided as base colors. When printing to a laminate film that is subjected to boiling processing and retort processing is considered, it is preferable that the pigment be appropriately selected in consideration of the migration property and heat resistance. The base inks for the respective colors are diluted with a diluting solvent to a viscosity and concentration suitable for gravure printing, and are supplied singly or as mixtures, to the respective printing units.

According to an embodiment of the ink composition of the present invention, the pigment is used in an amount within a range from 5 to 50% by weight, and more preferably within a range from 8 to 45% by weight, based on the total weight of the solid components in the ink composition.

### (Solvent)

The solvent used in the present invention may be a known solvent that is conventionally used in the related art. Specific examples thereof include alcohols such as methanol, ethanol, isopropanol, normal-propanol, isobutanol and normal-butanol; esters such as methyl acetate, ethyl acetate, isopropyl acetate, normal-propyl acetate, normal-butyl acetate and isobutyl acetate; hydrocarbons such as toluene, xylene, cyclohexane, normal-hexane and cyclohexane; and glycol ethers such as ethylene glycol monomethyl ether, ethylene glycol monoethyl ethers, ethylene glycol monobutyl ether, propylene glycol monomethyl ether, propylene glycol monoethyl ether, diethylene glycol monomethyl ether and diethylene glycol monobutyl ether. Concerning ethanol, synthetic ethanol and fermented ethanol, which is known as so-called bio-ethanol, can all be used.

Gravure printing involves the use of metallic intaglio plates. Gravure printing is known as a printing method appropriate in the case of performing printing in a large quantity at high speed. On the other hand, flexographic printing generally makes use of letterpress plates made of resins in many instances. Accordingly, even if the base material to which printing is applied is the same, it is preferable to select a solvent having a property of drying faster for the process of gravure printing. On the other hand, for the process of flexographic printing, it is preferable to select a solvent which lacks a tendency to swell resin plates. That is, in regard to inks for flexographic printing, it is preferable to use, not an aromatic solvent or a ketone-based solvent, but an alcohol-based solvent as a main solvent. For the inks for flexographic printing, those frequently used solvents can be used in combination, to an extent of not affecting the durability of the resin plate or the printing speed. Generally, an ink having a high pigment concentration is used in the inks for flexographic printing.

The ink composition is diluted with an organic solvent prior to the printing operation, until an appropriate viscosity is obtained. In general, the inks for gravure printing are adjusted to a viscosity within a range from 15 seconds to 23 seconds with Zahn Cup #3. The inks for flexographic printing are adjusted to a viscosity in the range of 18 seconds to 30 seconds with Zahn Cup #3. As such, it is preferable to select the solvent so as to obtain an appropriate ink formulation in accordance with the printing mode, and to appropriately adjust the amount of use of the solvent. Although it is not intended to be particularly limited, according to an embodiment of the ink composition of the present invention, the solvent is used in an amount within a range from 30 to 80% by weight, and more preferably within a range from 40 to 70% by weight, based on the total weight of the ink composition.

The ink composition according to the present invention may further contain, in addition to the binder, colorant and solvent as described above, various additives that are well known in the related art, such as an anti-blocking agent, a plasticizer and a wax, according to necessity. Furthermore, resins such as an acrylic resin, a maleic acid resin, a rosin-based resin, a chlorinated olefin resin, a cellulose-based resin, a vinyl chloride-vinyl acetate copolymer, an alkyd resin, a ketone resin and a polyamide resin, may also be used in combination as an additional binder component, as long as the resins are compatible with the polyurethane resin and do not impair storage stability. Furthermore, the ink composition of the present invention may also contain well-known additives such as a pigment dispersant which is adequately incorporated upon preparing the ink composition to improve fluidity and dispersibility of the ink.

### (Preparation of Ink Composition)

The ink composition according to the present invention can be prepared by dissolving and/or dispersing a binder and a colorant, as well as various additives that are used according to necessity, in an organic solvent. According to an embodiment of the present invention, the ink composition can be prepared by preparing in advance a pigment dispersion in which a pigment and a binder have been dispersed in an organic solvent, and incorporating other additional components to the resulting pigment dispersion if necessary.

Upon preparing the ink composition, it is preferable to use a known pigment dispersing machine that is conventionally used in the related art. For example, a roller mill, a ball mill, a pebble mill, an attriter or a sand mill can be used as the dispersing machine. The particle size distribution of the pigment in the pigment dispersion can be regulated by appropriately adjusting the size of the pulverizing medium of the dispersing machine, filling ratio of the pulverizing medium, duration of the dispersing treatment, ejection speed of the pigment dispersion, viscosity of the pigment dispersion, and the like. During the preparation of the ink composition, various additives such as a pigment dispersant may be incorporated to improve fluidity and dispersibility of the ink. Furthermore, if air bubbles or unexpected coarse particles and the like are present in the resulting ink, it is preferable to eliminate them by filtering or other methods, so as to prevent deterioration of the quality of printed matters. For the filtering device, those conventionally known ones can be used.

The ink composition prepared according to the method described above preferably has a viscosity within a range from 10 mPa·s to 1000 mPa·s. When the viscosity is adjusted to 10 mPa·s or higher, sedimentation of the pigment is prevented, and it is feasible to maintain adequate dispersibility. On the other hand, when the viscosity is adjusted to 1000 mPa·s or lower, the workability efficiency at the time of ink preparation or printing can be increased. Here, the viscosity is a value obtained by making a measurement at 25° C. with a B-type viscometer manufactured by Tokimec, Inc. The viscosity of the ink can be regulated by appropriately selecting the type of the various components used as raw materials, for example, the polyurethane resin, colorant, organic solvent and the like, and appropriately adjusting the respective mixing amounts. The viscosity of the ink can also be regulated by adjusting the particle size and particle size distribution of the pigment in the ink.

### (Flexographic Printed Matter and Laminate Film)

Since the ink composition of the present invention is alcohol-soluble, an ink formulation that is appropriate for flexographic printing can be provided. Also, the ink composition of the present invention is excellent in various properties such as fluidity, adhesiveness and anti-blocking property. Therefore, according to the present invention, even when an ink composition containing a urethane resin is applied to a printing process based on the flexographic printing method, workability is excellent, and high speed printing is made possible. Furthermore, a flexographic printed matter having a printed layer with excellent adhesiveness to a base material such as plastic film, can be efficiently provided by flexographic printing. Specific examples of the plastic film used as the base material include films formed from synthetic resins such as polyethylene terephthalate (PET), nylon (Ny) and stretched polypropylene (OPP). The thickness of such a base material is not particularly limited, and may be, for example, within a range from 8 to 250 μm, and more preferably from 12 to 50 μm. Also, the thickness of the printed layer provided on the base material is not particularly limited, but is preferably adjusted to a range from 0.1 to 5 μm, and more preferably from 0.2 to 2 μm. When the thickness of the printed layer is adjusted to the range shown above, it becomes easy to manifest desired characteristics satisfactorily, and workability tends to be enhanced.

As an embodiment of the present invention, a laminate film having various plastic films laminated on the printed layer of the flexographic printed matter, can be provided. Although the plastic films may be laminated directly to the printed layer, it is usually preferred that an adhesive is provided between the plastic films and the printed layer. Such a laminate film can be suitably used as a material for food packaging. Especially, since the printed layer formed from the ink composition according to the present invention has various properties that are desired, the laminate film can also be suitably used as a packaging material for food products that is considered for specific applications where boiling resistance and retort resistance are required.

In regard to the laminate film, specific examples of the plastic film used as the base material and the film thickness are as described previously. Meanwhile, as the plastic film that is laminated on the printed layer surface on the film base material, there may be mentioned films formed from synthetic resins such as polyethylene (PE) and unstretched polypropylene (CPP). The thickness of such a plastic film used for lamination is not particularly limited, and may be, for example, within a range from 10 to 50 μm, and more preferably from 15 to 30 μm. For the various plastic films used as the base material or for lamination in the present invention, use can also be made of products that have been subjected to a surface treatment such as corona treatment.

Lamination of each of the plastic films can be carried out according to methods such as dry lamination in which a resin film having heat sealability is pasted using a general solvent-type or solventless adhesive, for example, a polyurethane adhesive; and extrusion lamination in which a resin having heat sealability, such as a polyolefin resin, is melted and extruded to be laminated. Particularly, in the applications of packaging materials for food products where high quality laminate films are required, laminate films obtained by the dry lamination method are commonly used. The respective films that are laminated on the base material film during laminate processing, may be used singly, or may be used in a multilayer form composed of plural kinds of films. When a film having excellent heat sealability has been provided on the printed layer, a pouch-shaped packaging material formed from the laminate film can be easily produced by heat seal processing.

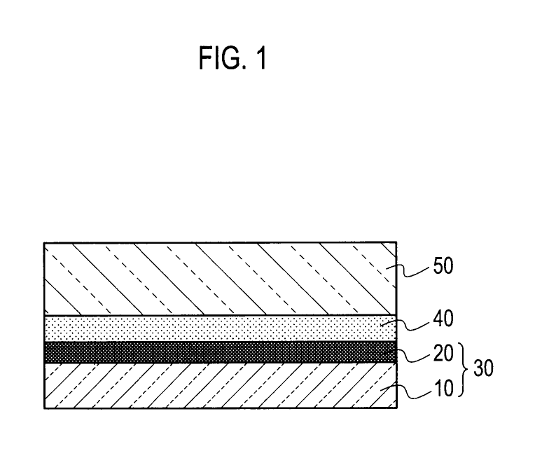

Although it is not intended to be particularly limited, as shown in FIG. 1 as a preferred embodiment of the present invention, a laminate film can be obtained by the following: using a stretched polypropylene (OPP) as a base material 10; producing a flexographic printed matter 30 by performing flexographic printing that the ink composition of the present invention is used and that provides a printed layer 20 onto the base material 10; and laminating a plastic film 50 such as a polyethylene (PE) film onto the printed layer 20 of the flexographic printed matter 30 via an adhesive 40.

### EXAMPLES

Hereinafter, the present invention will be explained in more detail by way of Examples. However, the present invention is not intended to be limited to the following Examples, and it is obvious that a wide variety of different embodiments can be constituted without departing from the scope of the invention. Additionally, various terms described in the Examples are defined as follows.

(1) The term “parts” indicates “parts by weight.”

(2) The term “molecular weight” is a value determined by measuring the molecular weight distribution using a gel permeation chromatography apparatus, as a molecular weight calculated relative to polystyrene standards.

(3) The term “viscosity” is a value obtained by making a measurement at 25° C. using a B-type viscometer.

(4) The term “amine value” is a value obtained according to a well-known titration method making use of a hydrochloric acid solution.

First, preparation of various resin components used as the binder components was carried out prior to the preparation of the ink composition.

### Synthesis Example 1

### Synthesis of Polyurethane Resin (a)

219.6 parts of a polyoxytetramethylene glycol having a number average molecular weight of 2000 and 56.6 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 4.4%. Subsequently, 11.6 parts of diethylaminoethanol was added to the obtained reaction product, and the mixture was allowed to react further for 3 hours at 90° C., to thereby obtain a prepolymer. The prepolymer was transferred to a drip tank using 115 parts of ethyl acetate.

Subsequently, 12.2 parts of isophorone diamine, 0.002 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (a) was obtained. The polyurethane resin (a) had a solids content of 30%, an amine value of 9.5, and a weight average molecular weight of 51,000.

### Synthesis Example 2

### Synthesis of Polyurethane Resin (b)

122.6 parts of a polyester diol formed from adipic acid and 3-methyl-1,5-pentanediol and having a number average molecular weight of 2,000, 132.9 parts of a polyoxytetramethylene glycol having a number average molecular weight of 2,000, and 37.6 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 1.2%. Subsequently, 0.399 parts of diethylaminoethanol was added to the obtained reaction product, and the mixture was allowed to react further for 3 hours at 90° C., to thereby obtain a prepolymer. The prepolymer was transferred to a drip tank using 115.0 parts of ethyl acetate.

Subsequently, 6.5 parts of isophorone diamine, 0.05 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (b) was obtained.

The polyurethane resin (b) had a solids content of 30%, an amine value of 0.6, and a weight average molecular weight of 71,000.

### Synthesis Example 3

### Synthesis of Polyurethane Resin (c)

177.3 parts of a polyester diol formed from adipic acid and 3-methyl-1,5-pentanediol and having a number average molecular weight of 2,000, 53.0 parts of a polyoxytetramethylene glycol having a number average molecular weight of 2,000, and 50.0 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 3.3%. Subsequently, 4.05 parts of diethylaminoethanol was added to the obtained reaction product, and the mixture was allowed to react further for 3 hours at 90° C., to thereby obtain a prepolymer. The prepolymer was transferred to a drip tank using 115 parts of ethyl acetate.

Subsequently, 15.5 parts of isophorone diamine, 0.12 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (c) was obtained. The polyurethane resin (c) had a solids content of 30%, an amine value of 5.9, and a weight average molecular weight of 47,000.

### Synthesis Example 4

### Synthesis of Polyurethane Resin (d)

236.5 parts of a polyoxytetramethylene glycol having a number average molecular weight of 2,000, and 47.3 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 2.8%, to thereby obtain a prepolymer. Subsequently, the prepolymer was transferred to a drip tank using 115 parts of ethyl acetate.

Subsequently, 16.1 parts of isophorone diamine, 0.122 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (d) was obtained. The polyurethane resin (d) had a solids content of 30%, an amine value of 0, and a weight average molecular weight of 29,000.

### Synthesis Example 5

### Synthesis of Polyurethane Resin (e)

236.5 parts of a polytetramethylene glycol having a number average molecular weight of 2,000, and 47.3 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 2.8%, to thereby obtain a prepolymer. Subsequently, the prepolymer was transferred to a drip tank using 115 parts of ethyl acetate.

Subsequently, 16.1 parts of isophorone diamine, 0.08 parts of dimethylaminoethanol, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (e) was obtained. The polyurethane resin (e) had a solids content of 30%, an amine value of 0, and a weight average molecular weight of 27,000.

### Synthesis Example 6

### Synthesis of Polyurethane Resin (f)

122.6 parts of a polyester diol having a number average molecular weight of 2,000 formed from adipic acid and 3-methyl-1,5-pentanediol, 132.9 parts of a polyoxytetramethylene glycol having a number average molecular weight of 2,000, and 37.6 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 1.2%. Subsequently, 0.2 parts of dimethylaminoethanol was added to the obtained product, and the mixture was allowed to further react for 3 hours at 90° C., to obtain a prepolymer. The prepolymer was transferred to a drip tank using 115.0 parts of ethyl acetate.

Subsequently, 6.5 parts of isophorone diamine, 0.05 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (f) was obtained. The polyurethane resin (f) had a solids content of 30%, an amine value of 0.4, and a weight average molecular weight of 73,000.

### Synthesis Example 7

### Synthesis of Polyurethane Resin (g)

219.6 parts of a polyoxytetramethylene glycol having a number average molecular weight of 2,000, and 56.6 parts of isophorone diisocyanate were fed into a four-necked flask equipped with a stirrer, a thermometer, a dropping funnel, a Dimroth condenser and a nitrogen gas inlet tube, and while nitrogen gas was introduced, the mixture was slowly heated to 90° C. and was allowed to react until the NCO % reached 4.4%. Subsequently, 12.6 parts of diethylaminoethanol was added to the obtained reaction product, and the mixture was allowed to further react for 3 hours at 90° C., to thereby obtain a prepolymer. Subsequently, the prepolymer was transferred to a drip tank using 115 parts of ethyl acetate.

Subsequently, 12.2 parts of isophorone diamine, 0.002 parts of dibutylamine, 345.0 parts of isopropyl alcohol and 240.0 parts of ethyl acetate were fed into a reaction tank, and the prepolymer was added dropwise from the drip tank to the reaction tank over 30 minutes. After completion of the dropwise addition, the mixture was allowed to react for one hour at 40° C., and thereby a polyurethane resin (g) was obtained. The polyurethane resin (g) had a solids content of 30%, an amine value of 9.9, and a weight average molecular weight of 49,000.

### Preparation Example 1

A cellulose acetate propionate resin (hereinafter, indicated as CAP resin) was mixed with various solvents at the mixing proportions shown below to dissolve therein, and thus a CAP varnish was prepared. “CAP-504-0.2 (trade name)” manufactured by Eastman Chemical Company was used as the CAP resin. This CAP resin had an acetyl group content of 2.5% by weight, a propionyl group content of 45% by weight, and a hydroxyl group content of 2.6% by weight, and had a glass transition temperature of 142° C.

### (Mixing Proportions)

| | |
|---|---|
| CAP resin | 20% |
| n-propyl acetate | 40% |
| Isopropanol | 40% |
| Total weight | 100% |

### Preparation Example 2

A cellulose acetate butyrate resin (hereinafter, indicated as CAB resin) was mixed with various solvents at the mixing proportions shown below to dissolve therein, and thus a CAB varnish was prepared. “CAB-321-0.1 (trade name)” manufactured by Eastman Chemical Company was used as the CAB resin. This CAB resin had an acetyl group content of 17.5% by weight, a butyl group content of 32.5% by weight, and a hydroxyl group content of 1.3% by weight, and had a glass transition temperature of 127° C.

### (Mixing Proportions)

| | |
|---|---|
| CAB resin | 20% |
| n-propyl acetate | 40% |
| Isopropanol | 40% |
| Total weight | 100% |

### Preparation Example 3

A polyvinyl butyral resin was mixed with various solvents at the mixing proportions shown below to dissolve therein, and thus a resin solution was prepared. “S-LEC BL-1 (trade name)” manufactured by Sekisui Chemical Co., Ltd. was used as the polyvinyl butyral resin. This resin had a number average molecular weight of about 19,000, a hydroxyl group content of about 36 mol % an acetyl group content of about 3 mol %, and a degree of butyralization of about 61 mol %.

### (Mixing Proportions)

| | |
|---|---|
| Polyvinyl butyral resin | 20% |
| n-propyl acetate | 40% |
| Isopropanol | 40% |
| Total weight | 100% |

### Examples 1 to 5 and Comparative Examples 1 to 8

Ink compositions were prepared using the components shown in Table 1 as raw materials. For the binder, the various polyurethane resins prepared in Synthesis Examples 1 to 7, and the solutions of the cellulose acetate alkylate resins and polyvinyl butyral resin obtained in Preparation Examples 1 to 3, were used. Preparation of each of the ink compositions was carried out by mixing predetermined amounts of the components shown in Table 1 as raw materials, preliminarily stirring and mixing the mixture using a high speed mixer until a uniform state was obtained, and then subjecting the resulting mixture to a dispersing treatment using a table sand mill filled with glass beads each having a diameter of 2 mm.

With regard to each of the obtained ink compositions, flow stability thereof and the viscosity stability after preparing two-component system with curing agent were evaluated respectively, as described below. The results are presented in Table 2.

### (Flow Stability of Ink)

A ratio of the viscosity (n1) measured using a BM-type viscometer after three rotations of rotor, and the viscosity (n2) measured after 60 rotations of rotor, (n2/n1), was determined and was designated as a TI value. The flow stability was evaluated from the obtained TI values according to the judgment criteria shown below. The TI value implies that as the value increases, the viscosity of the ink also tends to increase.

A: Fluidity of the ink is less than 1.1 in terms of the TI value.

B: Fluidity of the ink is 1.1 or greater and less than 1.3 in terms of the TI value.

C: Fluidity of the ink is 1.3 or greater and less than 1.8 in terms of the TI value.

D: Fluidity of the ink is 1.8 or greater in terms of the TI value.

(Viscosity Stability of Ink after Preparing Two-Components System of the Ink Composition and Curing Agent)

3 parts by weight of NYB curing agent (trade name, manufactured by Toyo Ink Manufacturing Co. Ltd., hexamethylene diisocyanate-based adduct, as an ethyl acetate solution with a solids content of 50%) was incorporated into 100 parts by weight of the previously prepared ink composition, and then the viscosity of the mixture was adjusted by diluting the mixture with a mixed solvent of propyl acetate and isopropyl alcohol (weight ratio 40:60). Viscosity adjustment was carried out such that the viscosity of the ink composition would be 20 seconds (25° C.) with Zahn Cup #3 (manufactured by Rigo Co., Ltd.). The ink composition which had been subjected to viscosity adjustment was placed in a container and stoppered, and the ink composition was left to stand for 24 hours at 40° C. After 24 hours, the viscosity of the ink was measured using a B-type viscometer, and the degree of viscosity change relative to the initial viscosity was calculated. From the obtained degree of viscosity change, the viscosity stability was evaluated according to the following judgment criteria.

A: The degree of viscosity change of the ink is less than 5%.

B: The degree of viscosity change of the ink is 5% or greater and less than 15%.

C: The degree of viscosity change of the ink is 15% or greater and less than 30%.

D: The degree of viscosity change of the ink is 30% or greater.

Next, a printed layer was formed on a base material using each of the obtained ink compositions, and the resulting printed matter was evaluated by performing the various tests described below. The results are presented in Table 2. The ink compositions were each diluted with a mixed solvent of propyl acetate and isopropyl alcohol (weight ratio 40:60) prior to the printing operation, and the viscosity was adjusted to 20 seconds (25° C.) with Zahn Cup #3 (manufactured by Rigo Co., Ltd.). Furthermore, the films used as the base material on which a printed layer was provided were as follows.

Corona-treated nylon film: “Emblem ON (trade name)” manufactured by Unitika, Ltd., thickness 15 μm. Hereinafter, the name will be abbreviated to “NY film.”

Corona-treated polyester film: “Lumira P60 (trade name)” manufactured by Toray Industries, Inc., thickness 12 μm. Hereinafter, the name will be abbreviated to “PET film.”

Corona-treated stretched polypropylene film: “Pylene P2161 (trade name)” manufactured by Toyobo Co., Ltd. Hereinafter, the name will be abbreviated to “OPP film.”

### (Tape Adhesiveness)

A printed layer (thickness 1 μm) of each of the ink compositions was formed on a base material using a flexographic printing machine, and thus printed matters were obtained. The OPP film and PET film were used as the base material. After these printed matters were left to stand for one day, Cellophane tape (adhesive tape manufactured by Nichiban Co., Ltd.) was adhered to the printed surface of each printed matter, and the tape was rapidly peeled off. The state of ink peel-off in the printed surface after the tape had been peeled off was judged by visual inspection. The judgment criteria are as follows.

A: No peeling occurs, with the area of ink peel-off being 0%.

B: The area of ink peel-off is smaller than 25%.

C: The area of ink peel-off is 25% or larger and smaller than 50%.

D: The area of ink peel-off is 50% or larger.

### (Anti-Blocking Property)

A printed layer (thickness 0.7 μm) of each of the ink compositions was formed on the PET film base material using a flexographic printing machine, and thus printed matters were obtained. The films were superimposed so that the printed surface and the non-printed surface of the printed matters would be brought to contact, and the films were exposed to an environment of 40° C. and 80% RH for 12 hours under a load of 5 kgf/cm². After 12 hours, the films were removed from the environment, and the state of ink transfer to the non-printed surfaces was evaluated by visual inspection. The judgment criteria are as follows.

A: The amount of ink transfer to the non-printed surface was 0%.

B: The amount of ink transfer to the non-printed surface was less than 10%.

C: The amount of ink transfer to the non-printed surface was 10% or more and less than 50%.

D: The amount of ink transfer to the non-printed surface was 50% or more.

### (Threading Property)

A printed layer (thickness 1.4 μm) of each of the ink compositions was formed on the OPP film base material using a flexographic printing machine, and thus printed matters were obtained. For each of the obtained printed matters, the presence or absence of filamentous dried matters occurring at the edges of the printing plate was judged by visual inspection. The threading property was evaluated from the number of dried matters confirmed by visual inspection, according to the following judgment criteria.

A: The filamentous dried matters occurring at the edges are completely absent.

B: There are 1 to 5 filamentous dried matters occurring at the edges.

C: There are 6 to 10 filamentous dried matters occurring at the edges.

D: There are 11 or more filamentous dried matters occurring at the edges.

Next, a laminate film was obtained by forming a printed layer (thickness 1.8 μm) on a base material by flexographic printing using each of the obtained ink compositions, and laminate processing a plastic film thereon, and an evaluation of the laminate film was made. The results are presented in Table 2. Here, the printed layer was formed using an ink having a composition of 3 parts by weight of NYB curing agent (trade name, manufactured by Toyo Ink Manufacturing Co., Ltd., hexamethylene diisocyanate-based adduct, as an ethyl acetate solution with a solids content of 50%) incorporated into 100 parts by weight of each of the previously prepared ink compositions. The PET film and Ny film were used as the base material. Production of the laminate film was carried out by dry laminate processing, by which a CPP film (thickness 25 μm) was pasted onto the flexographic printed matter obtained by flexographic printing, using TM220 and TM-215 (trade names, manufactured by Toyo-Morton, Ltd., isocyanate-based adhesives).

Pouch-shaped packaging materials were produced by heat seal processing the laminate films obtained as described above, and as the content to be packaged, a mixture of water/salad oil/vinegar=1/1/1 (weight ratio) was placed in each of the pouches, which was then sealed. The test samples thus obtained were used to evaluate the boiling resistance and retort resistance of the packaging materials in the following manner.

### (Boiling Resistance and Retort Resistance)

Boiling resistance was evaluated by heating a test sample at 100° C. for 30 minutes, and then determining, by visual inspection, the presence or absence of any abnormality in the external appearance such as swelling or loosening of the laminate film. Similarly, retort resistance was evaluated after heating the test sample for 30 minutes at 120° C. The respective judgment criteria are as follows.

A: There is no occurrence of delamination or blister, and the external appearance is retained.

B: Delamination or blister occurs at 1 to 3 sites per 50 cm².

C: Delamination or blister occurs at 4 to 10 sites per 50 cm².

D: Delamination or blister occurs at 11 or more sites per 50 cm².

TABLE 1
Compositions of Examples 1 to 5 and Comparative Examples 1 to 8

| | Example | | | | | Comparative Example | | | | | | | |
|---|---|---|---|---|---|---|---|---|---|---|---|---|---|
| | 1 | 2 | 3 | 4 | 5 | 1 | 2 | 3 | 4 | 5 | 6 | 7 | 8 |
| Type of pigment | Blue | RED | Yellow | White | Red | Blue | Blue | Red | Red | Red | Red | Red | Red |
| | 15:4 | 146 | 180 | 6 | 146 | 15:4 | 15:4 | 146 | 146 | 146 | 146 | 146 | 146 |
| Pigment | 130 | 130 | 130 | 350 | 130 | 130 | 130 | 130 | 130 | 130 | 130 | 130 | 130 |
| Polyurethane resin (a) | 324 | 376 | 376 | | | | | | | | | | |
| Polyurethane resin (b) | | | | 358.7 | | 395.7 | 304 | | 376 | 376 | | | |
| Polyurethane resin (c) | | | | | 376 | | | | | | | | |
| Polyurethane resin (d) | | | | | | | | 376 | | | | | |
| Polyurethane resin (e) | | | | | | | | | | | 324 | | |
| Polyurethane resin (f) | | | | | | | | | | | | 324 | |
| Polyurethane resin (g) | | | | | | | | | | | | | 324 |
| CAP varnish⁽¹⁾ | 25 | 12 | 42 | 3 | | 2.5 | 42 | 12 | | 36 | 25 | 25 | 25 |
| CAB varnish⁽¹⁾ | | | | | 12 | | | | | | | | |
| Polyvinyl | 89 | 24 | 6.6 | 9 | 24 | 4 | 102 | 24 | 36 | | 89 | 89 | 89 |
| butyral resin⁽¹⁾ | | | | | | | | | | | | | |
| Normal-propyl | 130 | 138 | 148 | 90 | 112 | 155 | 116 | 158 | 138 | 138 | 130 | 130 | 130 |
| acetate | | | | | | | | | | | | | |
| Isopropanol | 297 | 315 | 305 | 184.3 | 341 | 307.8 | 301 | 295 | 315 | 315 | 297 | 297 | 297 |
| Polyethylene wax | 5 | 5 | 5 | 5 | 5 | 5 | 5 | 5 | 5 | 5 | 5 | 5 | 6 |
| Polyurethane | 81 | 94 | 92 | 97.82 | 94 | 98.9 | 76 | 94 | | | 81 | 81 | 81 |
| Cellulose | 4.1 | 2 | 6.9 | 0.54 | 2 | 0.4 | 7 | 2 | 0 | | 4.1 | 4.1 | 4.1 |
| Butyral | 14.9 | 4 | 1.1 | 1.64 | 4 | 0.7 | 17 | 4 | | 0 | 14.9 | 14.9 | 14.9 |
| OH/NCO⁽²⁾ | 0.34 | 0.34 | 0.34 | 0.06 | 0.16 | 0.06 | 0.06 | — | 0.06 | 0.06 | — | 0.04 | 0.37 |
| Total | 1000 | 1000 | 1000 | 1000 | 1000 | 1000 | 1000 | 1000 | 1000 | 1000 | 1000 | 1000 | 1000 |

Remarks:
⁽¹⁾The value indicates the weight, expressed in parts by weight, including the solvent weight.
⁽²⁾The value indicates a molar ratio of the hydroxyl group in hydroxyldialkylamine to the isocyanate group in diisocyanate at the time of the preparation of prepolymer. Upon the preparation of prepolymers for the urethane resin (d) used in Comparative Example 3 and the urethane resin (e) used in Comparative Example 6, hydroxyldialkylamine was not used, and the content is indicated with “—” in the Table.

TABLE 2
Results for Examples 1 to 5 and Comparative Examples 1 to 8

| | Example | | | | | Comparative Example | | | | | | | |
|---|---|---|---|---|---|---|---|---|---|---|---|---|---|
| | 1 | 2 | 3 | 4 | 5 | 1 | 2 | 3 | 4 | 5 | 6 | 7 | 8 |
| Tape adhesiveness test (OPP) | B | A | A | B | B | B | D | D | D | D | C | B | C |
| Tape adhesiveness test (PET) | A | A | B | B | A | D | D | D | D | D | C | B | B |
| Anti-blocking property (PET) | A | A | A | B | A | D | B | D | A | A | B | C | B |
| Fluidity of ink | A | A | B | B | B | B | D | D | D | D | B | C | B |
| Viscosity stability after | B | A | A | B | B | D | D | D | D | D | C | C | C |
| preparing two-component | | | | | | | | | | | | | |
| system | | | | | | | | | | | | | |
| Stringing | A | A | A | B | B | D | D | B | D | D | C | B | B |
| Boiling resistance | | | | | | | | | | | | | |
| Ny | B | A | A | A | A | D | D | D | D | D | C | C | C |
| PET | B | A | A | A | A | D | D | D | D | D | C | B | C |
| Retort resistance | | | | | | | | | | | | | |
| Ny | B | A | A | A | A | D | D | D | D | D | C | C | C |
| PET | B | A | A | A | A | D | D | D | D | D | C | C | C |

As can be seen from the Table 2, it is obvious that the printing ink compositions for laminate according to the present invention are excellent in various properties. For example, as is obvious from a comparison between Examples 1 to 5 and Comparative Examples 4 and 5, it can be seen that the printing ink compositions for laminate of the present invention have their adhesiveness enhanced by using three kinds of resins such as a urethane resin, CAP and/or CAB, and polyvinyl butyral, as the binder. Furthermore, as is obvious from a comparison between Example 1 and Comparative Example 6, and a comparison between Examples 1 to 5 and Comparative Examples 7 and 8, it can be seen that the printing ink compositions for laminate of the present invention have their fluidity, viscosity stability, threading property, boiling resistance and retort resistance enhanced by using particular urethane resins as the binder.

1. A printing ink composition for laminate, used for forming a printed layer on a film base material to be laminate processed,
wherein the printing ink composition comprises a colorant, a solvent, and a binder composed of 80 to 98% by weight of a polyurethane resin, 0.5 to 5% by weight of a cellulose acetate alkylate resin and 1.0 to 15% by weight of a polyvinyl butyral resin, based on the total weight of the solids content,
wherein the polyurethane resin is a polyurethane resin obtainable by reacting a reaction product obtainable by a reaction between a component (A) and a component (B) as indicated below, with a component (C) to produce an isocyanate group-containing prepolymer, and further reacting the prepolymer with a component (D), and a molar ratio of the hydroxyl group in the component (C) to the isocyanate group in the component (B) is within a range from 0.05 to 0.35:
(A) a polyether diol compound having a number average molecular weight of 1,000 to 5,000, or a mixture of the polyether diol compound and a polyester diol compound having a number average molecular weight of 1,000 to 5,000;
(B) a diisocyanate compound;
(C) a hydroxyldialkylamine compound having a molecular weight of 50 to 300 and having one hydroxyl group in a molecule; and
(D) a chain extending agent.

2. The printing ink composition for laminate according to claim 1, wherein the cellulose acetate alkylate resin is a cellulose acetate propionate resin.

3. The printing ink composition for laminate according to claim 1, wherein the component (C) comprises at least one of diethylaminoethanol and dimethylaminoethanol.

4. The printing ink composition for laminate according to claim 1, wherein the polyether diol compound in the component (A) is polyoxytetramethylene glycol.

5. The printing ink composition for laminate according to claim 1, wherein a weight ratio of the polyether diol compound to the polyester diol compound in the component (A) is within a range from 100/0 to 20/80.

6. The printing ink composition for laminate according to claim 1, wherein the amine value of the polyurethane resin is within a range from 0.5 to 10.

7. A flexographic printed matter obtainable by forming a printed layer on a film base material according to a flexographic printing method, using the printing ink composition for laminate according to claim 1.

8. A laminate film obtainable by laminating a plastic film on the printed layer of the flexographic printed matter according to claim 7.

9. A packaging material for food products, comprising the laminate film according to claim 8.
